(19) United States
(12) Patent Application Publication
(10) Pub. No.: US 2020/0198242 A1
(43) Pub. Date: Jun. 25, 2020

(54) Post Processing Arrangement For Shaped Bodies Manufactured Additively By Photopolymerization

(71) Applicant: Ivoclar Vivadent AG, Schaan (LI)

(72) Inventor: Hendrik John, Buchs SG (CH)

(21) Appl. No.: 16/701,987

(22) Filed: Dec. 3, 2019

(30) Foreign Application Priority Data
Dec. 20, 2018 (EP) 18214382.6

(51) Int. Cl. B29C 64/35; B33Y 40/20; B29C 64/386; B33Y 50/00; B08B 3/10; B08B 3/08; B08B 7/04; B08B 3/04

(52) U.S. Cl. CPC B29C 64/35; B33Y 40/20; B29C 64/386; B08B 3/041; B08B 3/102; B08B 3/08; B08B 7/04; B33Y 50/00

(57) ABSTRACT

The present invention relates to a post processing arrangement for shaped bodies additively manufactured by photopolymerization, which arrangement includes a cleaning station holding ready a cleaning basin, and a finishing station for post-exposure of the shaped bodies, wherein the cleaning station (22) and the finishing station (42) are accommodated in a housing (2) in which in a lower section (20) the cleaning station (22) is located and vertically on top of it in an upper section (40) the finishing station (42) is accommodated, wherein the sections (20, 40) are in communication through a passage.

### CROSS-REFERENCE TO RELATED APPLICATIONS

This application claims priority to European patent application No. 18214382.6 filed on Dec. 20, 2018, the disclosure of which is incorporated herein by reference in its entirety.

### TECHNICAL FIELD

The present invention relates to a post processing arrangement for shaped bodies manufactured additively by photopolymerization which has a cleaning station for holding a cleaning basin, and a finishing station for post-exposure of the shaped body.

### BACKGROUND

There are now many procedures for manufacturing a shaped body from liquid, photopolymerizable material using stereolithography-based additive manufacturing (Rapid Prototyping) by location-selective exposure of successive layers. A layer of viscous, liquid material is defined on a construction platform and the layer is polymerized by location-selective exposure by an exposure unit in an exposure region with a contour predefined for the respective layer. Then a further layer of photopolymerizable material is defined on the polymerized layer and this last-defined layer is polymerized by exposure with a contour predefined for this last-defined layer. The two last-named steps are repeated until a shaped body with a predefined shape is formed by the sequence of cured layers with contours predefined in layers.

Such a method for manufacturing a shaped body is known for example from WO 2010/045950 A1 and corresponding U.S. Pat. No. 8,623,264B2, which is hereby incorporated by reference, which relate in particular to the manufacture of dental restorations from liquid, photopolymerizable materials. In the known method a construction platform is held vertically movable above a tank bottom which is transparent. There is an exposure unit underneath the tank bottom. The construction platform is initially lowered into the photopolymerizable material until only one layer of photopolymerizable material with the desired layer thickness remains between the construction platform and the tank bottom. This layer is then exposed with a predefined contour by the exposure unit and thereby cured. After the construction platform has been raised, photopolymerizable material is newly fed from the surroundings and the construction platform is lowered again, wherein the lowering is controlled such that the distance between the last-formed layer and the tank bottom defines a layer with the desired thickness. Thereafter, the last steps are repeated until a shaped body with the desired shape is produced by the sequential curing of layers with in each case a predefined contour.

After the polymerization of the last layer, the shaped body is removed from the manufacturing device by detaching the construction platform from a holder in the manufacturing device and removing it with the shaped body adhering thereto. In this phase the shaped body is still moist, i.e. wetted by liquid, photopolymerizable material. Furthermore, there can still be areas in the shaped body with incompletely polymerized material. The removed shaped body is therefore subjected to post processing for cleaning and finishing by post-exposure. For this the process is, for example, as follows in the state of the art, wherein the preamble of claim 1 relates to such post processing arrangement. The construction platform with the shaped body suspended thereon is pushed into a holder frame and this is then dipped into a first cleaning tank with isopropanol for coarse cleaning. The isopropanol bath is set in motion by magnetic stirrers in order to detach still adhering, unpolymerized material from the surface of the shaped body. After this coarse cleaning, the holder frame is removed from the cleaning tank and dipped into a second, separate cleaning tank for fine cleaning. Here too, the cleaning is aided by magnetic stirrers. Alternatively, ultrasound is also used as actuator, which is, however, very controversial and not recommended when handling solvents directly for health and safety reasons. The holder frame is then raised out of the second cleaning basin, and the shaped body is subsequently blown with pressurized air in order to remove the isopropanol with dissolved photopolymer and to dry the shaped body. Finally, the holder frame with the shaped body suspended thereon on the construction platform is placed in a separate finishing device and there subjected to a post-exposure in order to polymerize still unpolymerized residues in the shaped body. The handling of the construction platform held in the holder frame with the shaped body, as well as the transport thereof into and between the cleaning tanks and to the finishing device, is effected manually. The setting of the magnetic stirrers, the control of the cleaning durations in the two cleaning tanks as well as the setting of the operating parameters of the finishing device are also likewise effected manually by an operator. The operator must be protected with gloves in order not to come into contact with the moist shaped body or the cleaning liquids. Other system providers recommend removing the shaped bodies from the construction platform before the cleaning and finishing, wherein the shaped bodies themselves have to be touched/gripped and handled individually. This previously described post processing arrangement on the one hand requires a lot of space (two side-by-side cleaning tanks and a further post-processing device next to them) and on the other hand is personnel-intensive as the handling and the transport of the shaped body held in the holder frame has to be effected manually by personnel, who also have to set the operating parameters manually during the cleaning and during the finishing. The post processing in such a post processing arrangement is therefore personnel-intensive and error-prone as incorrect settings during the cleaning and during the finishing can result.

Besides, there is also already a post processing arrangement in which the two cleaning tanks are held side-by-side by a frame, with the result that the two cleaning tanks can be handled as a unit. However, the problem of the large amount of space required is not alleviated thereby, since the two tanks are arranged sideby-side and in this respect occupy a large surface area. Moreover, the finishing device, as a separate device, also occupies further space. The problems of the implementing steps of the finishing being personnel-intensive and the selection and setting of the correct implementing steps being error-prone are also not addressed thereby.

A post processing arrangement for shaped bodies generated by 3D printers is known from US 2016/0107392 A1, which is hereby incorporated by reference. In the post processing arrangement there are a single or several independent post processing devices. Devices for applying paint or for surface finishing by abrasives are named as post processing devices. The post processing device or devices and the 3D printer are connected to a communication unit which sends the 3D object information for controlling the 3D printer to the latter and sends post processing information to the post processing device or devices, which then automatically carry out the post processing operations on the basis of this information. In the case of several post processing devices, the shaped body to be finished is transported manually between the post processing devices or automatically by an automatic transport apparatus. The post processing processes of cleaning by liquid cleaning agent and finishing by post-exposure are not mentioned in the document.

### SUMMARY OF THE INVENTION

It is an object of the present invention to design a post processing arrangement for shaped bodies manufactured additively by photopolymerization, which arrangement is set up for the post processing steps of cleaning the shaped body in a liquid cleaning agent and finishing by post-exposure, in such a manner that it has a compact, space-saving design and that can conveniently and safely be operated by a user to carry out post processing.

The post processing arrangement comprising the features of the claims serves to achieve this object. Advantageous embodiments of the invention are set out in the dependent claims.

According to the present invention the post processing arrangement is designed such that the cleaning station and the finishing station are housed in a housing capable of standing on a horizontal stand surface. In a lower section of the housing the cleaning station is located, and, and in an upper section disposed vertically with respect to the stand surface on top of the lower section the finishing station is located. The lower section and the upper section are connected to each other by a passage. In the finishing station a holder is mounted to which the shaped body can be directly or indirectly attached, for example indirectly by attaching a construction platform from which the shaped body is hanging, which construction platform is inserted in the holder such that the shaped body is held in a position suitable for post-exposure. This is the case if the shaped body is accessible for the post-exposure radiation in the finishing station. Furthermore, the cleaning basin is carried by a lifting apparatus which is designed and arranged to be able to lift the cleaning basin from a holding position in the cleaning station vertically upward through the passage into the finishing station to a cleaning position in which the shaped body suspended on the holder is surrounded by the cleaning basin. In the cleaning position the upper edge of the cleaning basin is located vertically above the shaped body such that, if cleaning liquid is filled into the basin, the shaped body is completely immersed in the cleaning liquid. The cleaning basin can be lowered by the lifting apparatus in a corresponding manner from the cleaning position again back into the holding position in the cleaning station. The cleaning station thus comprises space for accommodating the cleaning basin in the holding position. Typically, the cleaning station also comprises a feeding device for cleaning liquid and a conduit connecting the feeding device to the cleaning basin; the lifting apparatus can also be located in the cleaning station, and can be located below the cleaning basin and may carry the cleaning basin on an extendable lifting element.

In addition there is a control unit which is arranged to control the operation of the lifting apparatus, of the closure and of the cleaning and finishing stations in such a manner that after suspending the shaped body on the holder the lifting apparatus raises the cleaning basin into the cleaning position in order to clean the shaped body with cleaning liquid in the cleaning basin. After completion of the cleaning procedure the lifting apparatus lowers the cleaning basin again to the holding position, whereafter the control unit controls the finishing station to perform post-exposure.

The integration of the cleaning station and the finishing station in a spatial relationship such that they are arranged vertically one above the other in a housing allows a particularly space-saving and compact design of the post processing arrangement. The arrangement of the cleaning station underneath the finishing station on top of it has the advantage that in such design the cleaning basin can be lifted up by the lifting apparatus from the lower holding position in the cleaning station upwards into the finishing station such that the shaped body suspended on the holder is immersed in cleaning liquid in the cleaning basin. After completion of the cleaning steps, for example successive cleaning steps with different cleaning liquids, movement of the cleaning liquid, for example by magnetic stirrers in the cleaning basin, the cleaning basin is, by operation of the lifting apparatus controlled by the control unit, automatically moved down into the cleaning station, wherein these steps are controlled by an operating program executed in the control unit. After that the control unit closes the closure at the passage, whereafter the control unit starts and controls the operation of the finishing station for the post-exposure of the shaped body. The arrangement of the cleaning station and the finishing station vertically one on top of the other in a housing capable of standing makes it possible to house the post processing arrangement on a very small foot print such that it can be installed in a space-saving manner.

Furthermore, an operator only has to suspend the shaped body to be post-processed on the holder, for example by inserting the construction platform with one or more shaped bodies hanging thereon into the holder, whereafter the post processing steps of cleaning and post-exposure proceed automatically under the control of operating programs executed in the control unit so that the operator during this time does not need to intervene and does not come in contact with the shaped body. The latter fact avoids dangers that the operator could come into contact with dangerous substances such as monomers or cleaning liquids adhering to the shaped body. In addition, the operator can during the execution of the post processing steps in the cleaning station and in the finishing station turn to other tasks.

In a preferred embodiment the passage is provided with a closure which according to a first alternative can be opened and closed by the control unit. In this case the control unit is arranged to drive the closure to open before the cleaning basin passes the passage when lifted up by the lifting apparatus, and to close the closure again after termination of the cleaning process and after the lifting apparatus has moved the cleaning basin downwards into the cleaning station. According to a second alternative the passage is provided with a closure which is passively opened by the cleaning basin when it is lifted up, and which after lowering the cleaning basin again passively closes. In both cases the interior space of the finishing station is closed by the closure with respect to the cleaning station when the post-exposure is to be carried out.

In a preferred embodiment a motor is provided which drives the holder to rotate the holder with the shaped body suspended thereon in order to clean the shaped body by centrifuging off adhering, unpolymerized liquid. The control unit is preferably arranged to start this step by activating the motor after the cleaning basin has been raised up from the holding position into the cleaning position in which the cleaning basin laterally surrounds the shaped body such centrifuged materials are collected in the cleaning basin. Thereafter the control unit may start the cleaning process by filling the cleaning basin with cleaning liquid.

Preferably the cleaning station is provided with a feeding device which is connected to at least one container for cleaning liquid. The feeding device is further connected to the cleaning basin by a flexible conduit to allow that cleaning liquid is pumped from the container into the cleaning basin. The flexible conduit between the feeding device and the cleaning basin has a sufficient length so that it may extend from the feeding device to the cleaning basin in the cleaning position such that the end of the flexible conduit connected to the cleaning basin may follow the vertical lifting movement of the cleaning basin into the cleaning position; the flexible conduit may for example unwind from a reel during the lifting movement. In addition the control unit is arranged to control the operation of the feeding device such that the cleaning basin is filled while it is lifted up by the lifting apparatus into the cleaning position and/or after it has been lifted up by the lifting apparatus into the lifting position, and to control thereafter the operation of the cleaning station during the cleaning process. For this purpose the control unit may for example activate a magnetic stirrer which is set in rotation in order to set the cleaning liquid in motion, thereby intensifying the cleaning process. Alternatively the cleaning process can be facilitated by setting the holder with the shaped body suspended thereon in rotation about a vertical rotational axis to thereby move the shaped body relatively to the surrounding cleaning liquid to thereby intensify the cleaning process.

Preferably the cleaning station is connected to at least two containers with cleaning liquids, and the feeding device is provided with a pump and a valve arrangement, wherein the pump and the valve arrangement are controlled by the control unit and selectively feed cleaning liquid from a selected one of the at least two containers into the cleaning basin, and to pump the cleaning liquid out of the cleaning basin after completion of the cleaning process. After the cleaning process has been completed the cleaning liquid typically is pumped out of the cleaning basin back into the contamer from which it has been extracted. After the cleaning with one cleaning liquid, the control unit may cause, in accordance with a cleaning program executed in the control apparatus, to activate the pump and the valve arrangement to pump another cleaning liquid from another selected container with cleaning liquid into the basin of the cleaning station, to carry out a further cleaning step and then pump the cleaning liquid out again. In this manner a cause cleaning step and then a fine cleaning step can be carried out, wherein in the cause a cleaning step cleaning liquid is used which has already been used a several times and which contains some contamination, whereas for the fine cleaning, cleaning liquid of higher purity is used. As already mentioned it is possible that, in order to set the cleaning liquid in motion and to thereby increase the cleaning affect, a magnetic stirrer at the basin bottom or an ultrasonic actuator may be activated.

In this way it is possible to carry out several cleaning steps with different cleaning liquids (chemically the cleaning liquids can have the same basic form, but contain different proportions of contaminations of photopolymerizable material from preceding cleaning steps) in a single basin, which requires much less space than the side-by-side cleaning tanks with the respective cleaning liquids as present in prior art arrangements.

In an advantageous embodiment, the finishing station is provided with at least two light sources for the post-exposure of the shaped body with different wavelengths. In this case the two (or more) light sources are selected such that their wavelengths include a combination of two or more of the ranges 360-370 nm, 380-390 nm, 400-410 nm and 455-465 nm.

In an advantageous embodiment the control unit is connected to an input device for receiving information about the properties of the shaped body to be finished. The control unit furthermore has a memory in which operating programs for the cleaning station and the finishing station and an allocation or assignment specification are stored, which assignment specification assigns one or more operating programs in accordance with the information of the properties of the shaped body. The control unit is set up to retrieve the associated operating programs for the cleaning station and the finishing station after the information about the properties of the shaped body has been received, and to control the cleaning station and the finishing station as required by the retrieved operating programs. The information about the properties of the shaped body may for example include information about the photopolymerizable material whereby the finishing station may be adjusted independent of the type of material in terms of exposure time, wavelengths of the post-exposure etc. in a manner specifically tailored to the shaped body actually to be post-processed.

The input device can for example be a manual input device on the post processing arrangement, which input device is defined for the manual input of information about the properties of the shaped body by a user. The input device may comprise, for example, a keyboard or a touch-screen.

Alternatively, the input device comprises a reading apparatus which is designed to read a data storage medium connected to the construction platform or the shaped body or a data carrier assigned to the latter with information about the properties of the shaped body. For example, the data storage medium is an RFID transponder connected to the construction platform, which transponder contains information about the shaped body manufactured on the construction platform. The information about the shaped body may comprise geometric properties, construction materials used and construction parameters such as exposure times, etc. Alternatively, the data storage medium can be barcode or a DataMatrix code which is applied to the construction platform or is integrated in the shaped body and which is detected by a reader and transmitted to the post processing arrangement before the construction platform is inserted in the holder of the post processing arrangement.

In an advantageous embodiment the holder for suspending the shaped body is designed such that the shaped body is held on the holder in such a manner that it is hanging thereon extending in a downward direction such that the shaped is freely accessible for the radiation of the light sources of the finishing station at least from the lower hemisphere, and is accessible for the cleaning liquid in the cleaning basin during the cleaning process. In other words there is, at least over the lower hemisphere underneath the holder, free access to the shaped body for the radiation of the finishing station and for cleaning liquid in the cleaning basin.

In a preferred embodiment the holder is designed such that a construction platform with the shaped body or shaped bodies hanging thereon may be suspended on the holder such that the shaped body hangs on the construction platform pointing in downward direction and is freely accessible below the holder, i.e. there is free access to the shaped body at least over the lower hemisphere below the construction platform for the radiation of the finishing station and for cleaning liquid in the cleaning tank. In this embodiment, after completion of the construction process on the construction platform, the shaped body, adhering to the construction platform, is removed from the manufacturing device and is then inserted with the construction platform into the post processing arrangement. The holder may for example be provided with an adapter, which allows suspending construction platforms of different sizes.

In a preferred embodiment the upper section of the housing, in which the finishing station is housed, is provided in its outer wall with a flap that can be open to provide access to the interior of the finishing station, wherein the flap is arranged such that the shaped body or the construction platform may be inserted through the opening of the opened flap and may be inserted directly into the holder. In a corresponding manner the flap, after completion of the post processing, may be opened in order to remove the finished shaped body.

In a preferred embodiment the upper section and the lower section of the housing are detachably connected to each other. This means that the finishing station in the upper section and the cleaning station in the lower section can each be formed as modules which can be connected to each other lying vertically one above the other and which each have an opening which, in the connected state of the upper and lower sections, are lined with each other and form the passage for vertically transporting the cleaning basin between the cleaning station and the finishing station. The closure for selectively opening or closing the passage is then provided at the opening of the lower wall of the upper section or at the opening of the upper wall of the lower section.

In a preferred embodiment the control unit is housed in a detachable third section of the housing. The upper and lower sections, which can be detached from the each other, and the third section of the housing are designed such that the third section with the control unit can be attached to the lower section underneath the latter. There are electrical connections which connect the control unit to the cleaning station and the finishing station. The upper section can also be designed such that the upper section can also be placed on the third housing section when the upper section is detached from the lower section. In this embodiment it is possible in principle to operate the finishing station and the cleaning station also as a separate unit, in case a separate operation is advantageous in particular situations.

### BRIEF DESCRIPTION OF THE DRAWINGS

The invention is described below with reference to exemplary embodiments in the drawings in which:

FIGS. 1 and 2 show schematic cross-sectional views of a finishing station for the post processing arrangement shown in FIG. 3,

FIG. 3 shows a schematic cross-sectional view of an embodiment of the post processing arrangement,

FIG. 4 shows a cross-sectional view of the post processing arrangement of FIG. 3, wherein parts that can be detached from each other have been detached from each other,

FIGS. 5a to 5c show cross-sectional views of the post processing arrangement in three subsequent states in the course of a post processing procedure, and

FIGS. 6a to 6c show schematic cross-sectional views of three further states of the post processing procedure following the states of FIGS. 5a to 5c.

### DETAILED DESCRIPTION

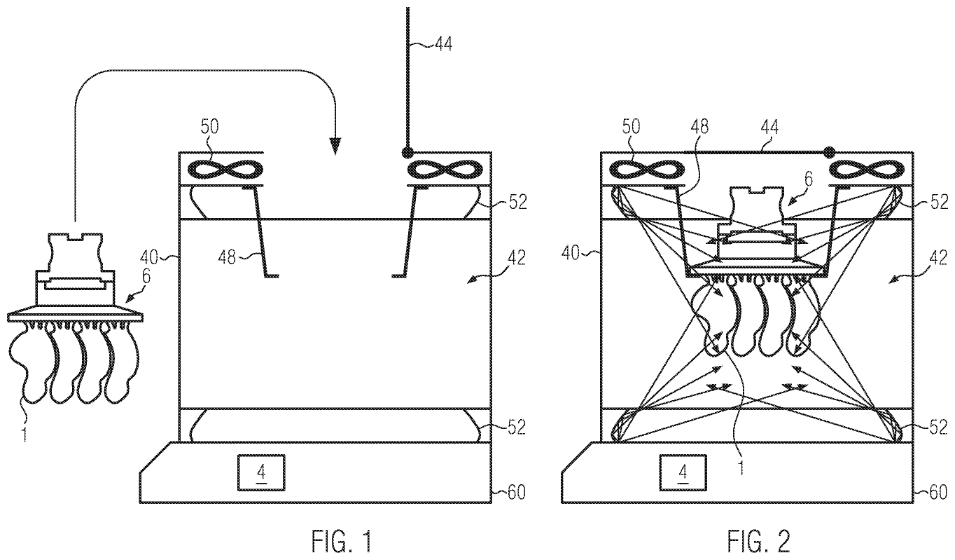

In FIGS. 1 and 2, a finishing station 42 is first shown which is shown detached from a cleaning station of a post processing arrangement in order to illustrate the design and function of the finishing station. The finishing station 42 has a cylindrical upper housing section 40 in which close to its upper and lower ends circumferentially extending reflectors 50 are attached which reflect light from light sources (not shown) which are disposed circumferentially distributed, into a central exposure area. Due to the shape of the reflectors 52, the light reflected is distributed over a wide range along a central axis and distributed about the central axis over a larger area. The light beams which are reflected by the reflectors 52 are shown in FIG. 2 by a group of arrows. Several types of light sources with different maximum emissions can be disposed circumferentially distributed such that exposures with desired wavelengths can be carried out.

On the left hand side in FIG. 1 shaped bodies 1, here in the form of dental prosthesis bases, are represented schematically, which shaped bodies after manufacture by stereolithography are still hanging on a construction platform 6. The construction platform 6 has been removed after termination of the building process from a stereolithography 3D printer. The construction platform 6 is, with the shaped bodies 1 hanging thereon, moved through an opening in the outer wall of the upper section 40 of the housing, provided with a flap 44, into the interior of the finishing station 42, as schematically indicated by the arrow in FIG. 1, and in the interior is suspended on a holder 48. The holder 48 may for example comprise a plurality of bars projecting into the interior of the finishing station, which bars have, at their ends in the interior space of the finishing station, angled, horizontal end sections which can engage the lower surface of the construction platform 6 such that the construction platform rests on these horizontal end sections.

The bars of the holder 48 may be elastic to allow construction platforms over a certain size range to be suspended in such holder 48.

Once the shaped body 1 is suspended with the construction platform 6 on the holder 48, in principle the exposure of the shaped bodies 1 for their finishing, shown in FIG. 2, cold be carried out. In a post processing arrangement according to the invention first a cleaning process is conducted after the finishing station 42 is supplied with the construction platform 6 including shaped bodies 1, which cleaning process is described further below.

The finishing station 42 is provided with schematically represented fans 50 which dry the shaped bodies, after the cleaning, by a generated airflow and which cool the finishing station 42 during the post-exposure. In addition, the fans 50 guarantee that solvent vapours are discharged from the finishing station in order to prevent a possible ignition during the post-exposure.

FIGS. 1 and 2 show the upper housing section 40 placed on a third housing section 60 in which a control unit 4 for controlling the different components of the post processing arrangement is housed. In this configuration the finishing station 42 can also be operated separately. In FIG. 4, the electrical connection is indicated by a dashed line 66 within the cleaning station 22, which conducting line indicates the connection of the finishing station to the control unit 4 when all housing sections are arranged on top of each other and are connected to each other.

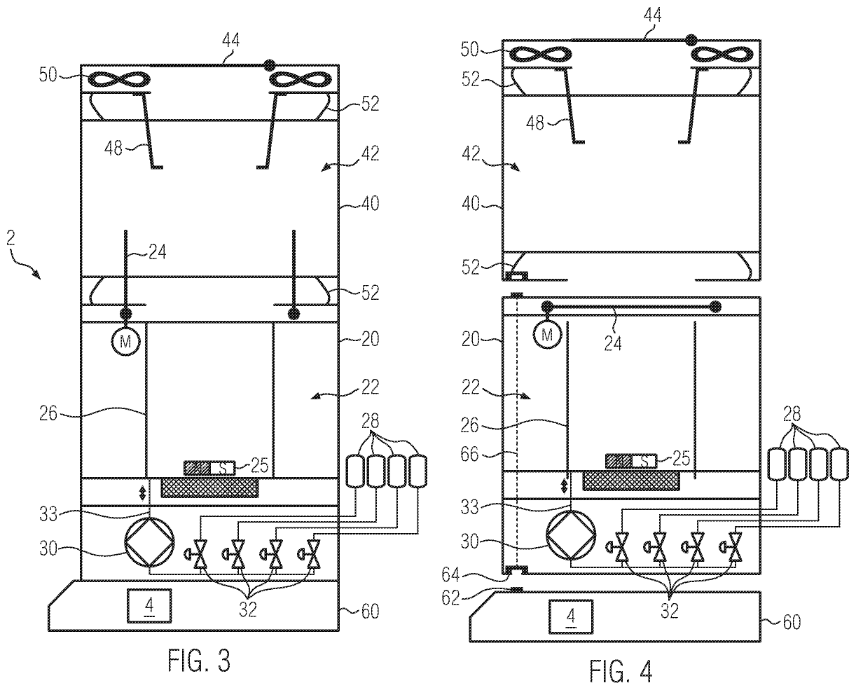

In FIG. 3 the post processing arrangement having a housing 2 in the assembled state is shown in a schematic cross-sectional view.

The cleaning station 22 is disposed in the lower section 20 of the housing 2. The upper wall of the lower housing section 20 is provided with an opening having a closure 24 which is shown in the opened state in FIG. 3. The closure 24 can be operated by a schematically indicated motor M which is controlled by control unit 4 to open or close closure 24. Alternatively the closure can be passively opened by lifting up the cleaning basin to push open the closure. In the bottom wall of the upper section 40 of the housing 2 there is an opening which is aligned to the opening with the closure 24 such that after opening of the closure 24 a passage from the interior space of the lower section 20 into the interior space of the upper section 40 is open.

In the cleaning station 22 in the lower housing section 20 there is a cleaning basin or vat 26 open at the top, wherein the cleaning basin 26 is disposed in the cleaning station 22 if the cleaning basin 26 is in the holding position. The cleaning station 22 furthermore comprises a pump 30 and a series of valves 32 connected to the pump. External containers 28 including cleaning liquids are connected to the valves 32. The pump 30 is connected to the cleaning basin 26 by a schematically indicated conduit 33.

The cleaning basin 26 is furthermore provided with a magnetic stirrer 25 which, when the cleaning basin 26 is filled with cleaning liquid, sets the cleaning liquid in motion in order to intensify the cleaning process. Alternatively or in addition to the magnetic stirrer an ultrasonic actuator may be provided at the lower surface of the cleaning basin bottom or on the sidewalls of the cleaning basin.

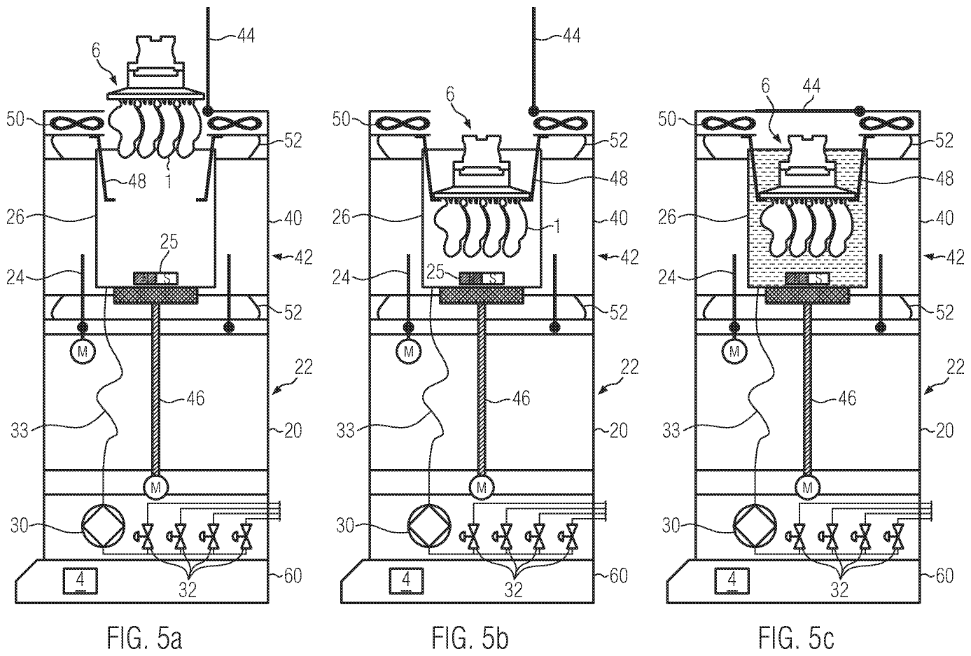

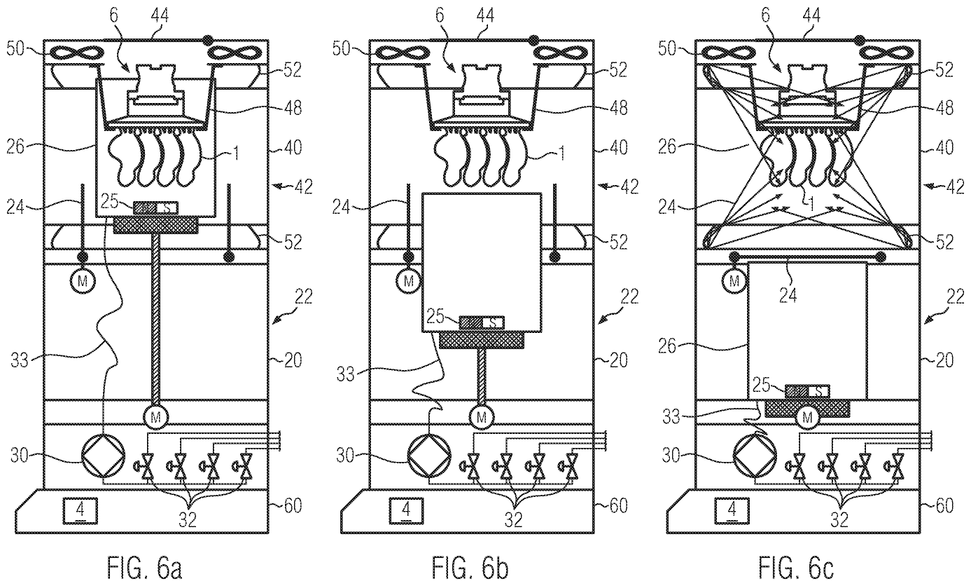

The cleaning station 22 is further provided with a lifting apparatus 46 which in FIGS. 5a to 5c and 6a to 6b is illustrated by a schematically indicated motor and by a spindle. The lifting apparatus 46 may be implemented with a spindle drive. Alternatively, a toothed rack may be mounted on an inner wall of the lower housing section 20 which is engaged by a motor driven gear wheel, wherein the motor also carries the cleaning basin 26, which is capable of moving the cleaning basin 26 from the holding position in the lower section 20 of the housing vertically upwards into the finishing station 42 into the cleaning position and subsequently lowering the cleaning basin again into the holding position in the cleaning station 22. In the cleaning position the shaped body suspended on the holder 48 is surrounded by the cleaning basin, i.e. the upper edge of the sidewalls of the cleaning basin 26 is located vertically above the shaped body 1 so that after filling the cleaning basin 26 with cleaning liquid the shaped bodies 1 are completely immersed in cleaning liquid.

In principle also telescopic rods having a plurality of intertwined telescope elements can be utilized for the lifting apparatus, which telescopic rods carry the cleaning basin 26 and which are adjustable in terms of their lengths to be able to lift the cleaning basin 26 from the holding position in the cleaning station 22 up into the cleaning position in the finishing station 42 and to lower it down again. Alternatively scissor lift mechanisms may be used for this purpose.

In FIG. 4 the modular design of the housing of the post processing arrangement is illustrated: The upper section 40, the lower section 20 and the third section 60 are shown here detached from each other. The sections can be connected to each other by plug-in connecting structures which are not shown in further detail here. At the third section 60 a contact 62 is schematically indicated which comes into conducting contact with a contact 64 at the lower section 20 when the third section 60 and the lower section 20 are connected to each other. In fact the contacts 62, 64 may include several separate contacts so that besides an energy supply connection also one or more parallel data transfer line or a data bus can be connected. The dashed line 66 indicates connecting cables which lead from the contact 64 through the lower section to a contact at the upper end of the lower section 20 which in turn is in conducting connection with a contact at the lower end of the upper section. In this manner the lower and upper sections 20, 40 can be supplied with electric energy and can exchange data with the control unit 4 when the control unit controls the operation of the cleaning station and of the finishing station as will be described in the following example.

Now an exemplary embodiment will be described as to how the control unit 4 may control the various components for carrying out the finishing process, wherein first reference is made to FIGS. 5a to 5c. In FIG. 5a the flap 44 at the top of the finishing station 42 is opened. A construction platform 6 with shaped bodies 1 hanging thereon is lowered from above through the opening of the flap 44 into the finishing station 42 and is lowered into the interior space until outer edge regions of the construction platform 6 rest on the holder 48 such that the construction platform 6 is suspended on the holder 48. The beginning of this process is shown in FIG. 5a, and the suspended state of the construction platform 6 with the shaped bodies 1 in the holder 48 is shown in FIG. 5b. In FIGS. 5a and 5b the cleaning basin 26 is shown as already moved by the lifting apparatus 46 into the elevated cleaning position in which the cleaning basin 26 is located in the interior space of the finishing station 42. In this cleaning position of the cleaning basin 26 the cleaning basin 26 surrounds the shaped bodies 1, i.e. the shaped bodies 1 are located below the upper edge of the cleaning basin 26. After insertion of the construction platform 6 into the holder 48 and after closing the flap 44 the cleaning process is started by the control unit 4 controlling the pump 33 and the valves 32 in order to pump a selected cleaning liquid through the conduit 33 into the cleaning basin 26. The cleaning basin 26 is shown in FIG. 5c in the completely filled state.

The conduit 33 is illustrated in FIGS. 5a to 5c as a flexible conduit, illustrated in a simplified manner by a line with a curved extension; the length of the conduit 33 is sufficient such that the end of the line connected to the cleaning basin 26 may follow the movement of the cleaning basin 26 into the elevated cleaning position in the finishing station 42. The flexible conduit 32 for supplying cleaning liquid can be laid in a helical configuration to be able to extend over a larger length when the cleaning basin 26 is lifted up from the holding position into the cleaning position shown in FIGS. 5a to 5c. In FIGS. 5a to 5c the filling of the cleaning basin 26 with cleaning liquid starts when the cleaning basin 26 is already located in the elevated cleaning position. In principle, also embodiments are possible in which the filling of the cleaning basin 26 by activation of the pump 30 already start at the same time as the lifting process such that the cleaning basin 26 may already be partially or completely filled when it reaches the elevated cleaning position. It is also conceivable that the lifting process for raising the cleaning basin 26 by the lifting apparatus 46 into the elevated cleaning position only starts after the construction platform with the shaped bodies 1 has been inserted into the holder 48.

After termination of the cleaning step the pump 30 pumps the cleaning liquid out of the cleaning basin 26 again, wherein in most cases the cleaning liquid is then pumped back into the container 28 (see FIGS. 3 and 4) from which it was extracted before and pumped into the cleaning basin. In this manner the cleaning liquid may be used again. The containers may hold cleaning liquids of different types or of different purities such that subsequent cleaning steps with different cleaning liquids can be carried out by successively pumping cleaning liquids out of particular containers 28. For example, first a cause cleaning may be carried out by feeling a first cleaning liquid from a first of the containers 28, and after pumping out the cleaning liquid for the cause cleaning, a cleaning liquid of higher purity is extracted from another of the containers 28 and pumped into the cleaning basin in order to carry out a posed cleaning step.

FIG. 6a which shows a state after termination of the last cleaning step when the cleaning liquid used in the last step has already been pumped out of the cleaning basin 26 again. Thereafter the control unit 4 controls the operation of the post processing arrangement further by activating the lifting apparatus 46 in order to lower the cleaning basin from the elevated cleaning position in FIG. 6a vertically downwards, wherein in FIG. 6b an intermediate point in time during the lowering process is shown in which the cleaning basin is already lowered part of the way downwards into the cleaning station 22. When the cleaning basin 26 has been completely lowered into the cleaning station 22 in the lower section 20 of the housing, as shown in FIG. 6c, the control unit 4 stops operation of the lifting apparatus 46 and closes the closure 24 such that the interior space of the finishing station 42 now is closed against the interior space of the cleaning station 22. Thereafter, the control unit 4 activates the fans 50, in order to dry the shaped bodies 1 to which cleaning liquid may still adhere.

Thereafter the control unit may initiate post-exposure as shown in FIG. 6c. For this purpose the control unit 4 executes a selected operating program operating predefined light sources for each case a light source with predefined intensity over an exposure time which is likewise predetermined by the operating program in order to completely polymerize not yet fully cured zones in the shaped body. Finally, after completion of the post-exposure, the flap 44 of the upper housing section 40 may be opened, and the construction platform 6 with the shaped bodies 1 thereon may be lifted up out of the holder 48 and may be removed from the finishing station 42, which terminates the post processing of the shaped body 1.

After introducing the shaped bodies to be post-processed into the post processing arrangement in FIG. 5a and before removing the shaped bodies 1 therefrom as just described, all post processing steps as described before can be carried out automatically and controlled by the control unit 4 in which a selected stored operating program is executed. The finishing process is in this manner less personnel-intensive, and there are no risks of individual steps being carried out incorrectly or inadequately by the personnel, as the steps run according to predefined programs.

As an alternative to drying by use of the fans 50, in an embodiment not shown in the Figures the post processing arrangement may comprise a pressurized air source which is controlled by the control unit 4 and which after termination of the cleaning procedure directs pressurized air from the pressurized air source through nozzles in order to blow away still adhering cleaning liquid by means of pressurized air to thereby improve the cleaning and drying process of the shaped bodies. In a preferred embodiment air nozzles can be provided in the form of air valves, i.e. the valve opening is shaped as an elongated valve slit which extends for example in an angular manner around the shaped bodies 1, when these are suspended in the holder 48, in order to direct pressurized air from all directions to the shaped bodies 1 in order to remove residual cleaning liquid in a particularly effective manner and to dry the shaped bodies.

In a further embodiment the holder 48 may be mounted to be rotatable about a vertical axis of the finishing station, and a motor may be provided which is capable of setting holder with the shaped bodies suspended thereon in rotation in order to spin off residual, adhering cleaning agent, instead of blowing it off. In such an embodiment the shaped bodies may, for example in the stage shown in FIG. 5b before beginning of the cleaning process, set into fast rotation in order to centrifuged or spin off still adhering, unpolymerized building material from the building process before the further cleaning with cleaning liquids is carried out.

The rotation of the holder about a vertical axis can also be used in the stage shown in FIG. 5c in order to rotate the shaped bodies in the cleaning liquid in the cleaning basin 26 to thereby intensify the cleaning effect by relative motion of the cleaning liquid with respect to the shaped bodies, wherein such rotation in the cleaning liquid is to be carried out with lower rotational frequency as a possible rotation of the shaped body for spinning off of adhering liquid.

The manner of the cleaning to be carried out and the manner of the post-exposure to be carried out generally depend on properties of the shaped bodies to be finished. For example, the selection of both of the wavelengths and the intensities of the post-exposure to be carried out depends on the size, the shape and the type of material of the shaped body and the type of photopolymer which was used to produce the shaped body. The cleaning steps to be performed likewise depend on properties of the shaped body to be finished in the specific case. For these reasons the post processing arrangement is advantageously connected to an input device for receiving information about the properties of the shaped body to be finished. The input device can be part of the post processing arrangement and can be connected to the control unit and/or computer. Furthermore, the control unit is provided with a number of stored operating programs for the cleaning station and the finishing station as well as with an assignment or allocation specification which links information on the properties of the shaped bodies to particular operating programs suitable for the properties of the shaped bodies according to the information. The information received by the input device regarding the properties of the shaped body can be used by the control unit in order to retrieve, using the allocation specification, one or more suitable operating programs, and to execute these programs in the desired manner, wherein the operation of the post processing arrangement is carried out in accordance with this or these operating programs in a completely automatic manner, without need for intervention by personnel.

The input device for the information about the properties of the shaped body can be a manual input device for manual input of information about properties of the shaped body by a user, for example a keyboard or a touch-screen. Alternatively, an automatic reading device can act as the input device, which reading device is set up to read a data storage medium connected to the shaped body or assigned to it and including the information on the properties of the shaped body. For example, a data storage medium in the form of a barcode or a data matrix code can be attached to the upper side of the construction platform 6 facing away from the shaped bodies 1 or can be part of the shaped body and can contain information about the manufactured shaped bodies 1 suspended thereon. This storage medium can be read out by a code reader as an input device, in order to transmit this information regarding the shaped bodies 1 to control unit 4 which then uses a stored allocation or assignment specification to allocate one or more operating programs in accordance with the received information for controlling the post processing arrangement by execution of this/these operating programs. The entire processing process can be carried out in this manner in a completely automatic manner in a compact post processing arrangement, without any need for an operator to intervene, except for the introduction of shaped bodies and their removal after the post processing. Furthermore, there is no risk for any operating personnel to come into contact with cleaning liquids or the like.

In some embodiments, the control unit can be a processor such as a single processor having one or more cores, or a plurality of processors connected by a bus, network, or other data link. The electronic data storage unit can be any form of non-transitory computer-readable storage medium suitable for storing the data produced by the system.

In some embodiments, the processor is in communication over a network, which could be wired or wireless, with an external processor used for performing one or more calculation steps and/or a network-attached electronic data storage unit. In some embodiments, the present disclosure makes use of cloud computing to perform one or more calculations steps remotely and/or remote storage to enable the storage of data remotely for collaborative or remote analysis.

In some embodiments, a computer may be utilized as the control unit or processor and can include any computational device that performs logical and arithmetic operations. For example, in some cases, a computer comprises an electronic computational device, such as an integrated circuit, a microprocessor, a mobile computing device, a laptop computer, a tablet computer, a personal computer, or a mainframe computer. In some cases, a computer comprises: (a) a central processing unit, (b) an ALU (arithmetic logic unit), (c) a memory unit, and (d) a control unit that controls actions of other components of the computer so that encoded steps of a program are executed in a sequence. In some cases, a computer also includes peripheral units including an auxiliary memory storage device (e.g., a disk drive or flash memory), or includes signal processing circuitry.

Although the invention is illustrated above, partly with reference to some preferred embodiments, it must be understood that numerous modifications and combinations of different features of the embodiments can be made. All of these modifications lie within the scope of the appended claims.

1. A post processing arrangement for shaped bodies manufactured additively by photopolymerization comprising
a cleaning station for holding ready a cleaning basin for the shaped body, and
a finishing station for post-exposure of the shaped body,
wherein the cleaning station (22) and the finishing station (42) are housed in a housing (2) capable of standing on a horizontal stand surface, in which housing the cleaning station (22) is housed in a lower section (20) and the finishing station (42) is housed in an upper section (40) lying vertically on top of the lower section, wherein the lower and upper sections (20, 40) are connected to each other by a passage,
wherein a holder (48) is mounted in the finishing station (42), on which holder the shaped body (1) can be suspended directly or indirectly,
wherein the cleaning basin (26) is carried by a lifting apparatus (46),
wherein a control unit (4) is arranged to control the operation of the lifting apparatus and the cleaning and finishing stations (22, 42) in such a manner that after positioning the shaped body on the holder (48) the lifting apparatus (46) lifts the cleaning basin (26) to a cleaning position in order to clean the shaped body (1) with cleaning liquid in the cleaning basin, and, after completion of the cleaning process, moves the cleaning basin (26) by the lifting apparatus (46) downwardly to a holding position in the cleaning station, and controls operation of the finishing station (42) thereafter for post-exposure.

2. The post processing arrangement according to claim 1,
wherein the passage is either
(i) provided with a closure (24) adapted to be opened and closed by the control unit controlling an actuator, wherein the control unit is arranged to open the closure (24) before the cleaning basin (26) is lifted by the lifting apparatus and passes the passage, and to close the closure (24) after the cleaning basin (26) is moved by the lifting apparatus (46) downwardly into the cleaning station after completion of the cleaning process, or
(ii) is provided with a closure which is passively opened by the cleaning basin (26) when the cleaning basis is lifted up, and which is passively closed after lowering the cleaning basin (26) again.

3. The post processing arrangement according to claim 1,
wherein the holder (48) is mounted to be rotatable about a vertical axis, and
wherein a motor is provided which drives the holder (48) in order to set the holder with the shaped body suspended thereon in rotation in order to clean the shaped body by centrifuging off still adhering photopolymerizable liquid therefrom.

4. The post processing arrangement according to claim 1,
wherein the cleaning station (22) is provided with a feeding device (30, 32) which is connected to at least one container (28) holding cleaning liquid,
wherein the feeding device is connected by a flexible conduit (33) to the cleaning basin (26),
wherein the flexible conduit (33) has a length that is sufficient in order to extend from the feeding device to the cleaning basin (26) in the cleaning position,
wherein the control unit (4) is arranged to control the feeding device such that the cleaning basin (26), while being lifted up by the lifting apparatus (46) to the cleaning position and/or after having been lifted up by the lifting apparatus (46) to the cleaning position, is filled with cleaning liquid, and
wherein the control unit is configured to control the operation of the cleaning station during the cleaning process.

5. The post processing arrangement according to claim 3,
wherein the control unit (4) is furthermore arranged to activate the motor connected to the holder (48) while the cleaning process is carried out and to set the shaped body (1) in rotation in the cleaning liquid in order to intensify the cleaning effect.

6. The post processing arrangement according to claim 4,
wherein the cleaning station (22) is connected to at least two containers (28) holding cleaning liquids, and
wherein the feeding device is provided with a pump (30) and valves (32) which under control of the control unit selectively feed cleaning liquid from a selected one of the at least two containers (28) into the cleaning basin (26) and pump the cleaning liquid out of the cleaning basin (26) again after completion of the cleaning process.

7. The post processing arrangement according to claim 1,
wherein the finishing station (42) is provided with at least two light sources for post-exposure with different wavelengths, wherein the different wavelengths are within the range from 300 nm to 500 nm.

8. The post processing arrangement according to claim 1,
wherein the control unit (4) is connected to an input apparatus for receiving information about properties of the shaped body to be finished and is provided with a memory in which operating programs for the cleaning station (20) and the finishing station (42) and an allocation specification are stored which allocates operating programs according to the information on the properties of the shaped body, and
wherein the control unit is arranged to retrieve the allocated operating programs after the information about the properties of the shaped body has been received and to control the cleaning station (22) and the finishing station (42) by execution of the retrieved operating programs.

9. The post processing arrangement according to claim 8,
wherein the input device is a manual input device for manual input of information about properties of the shaped body by a user.

10. The post processing arrangement according to claim 8,
wherein the input device comprises an automatic reading device which is designed to read a data storage medium including information on the properties of the shaped body, which data storage medium is connected to or assigned to the shaped body.

11. The post processing arrangement according to claim 1,
wherein the holder (48) for suspending the shaped body (1) is configured such that the shaped body (1) is held hanging thereon such that that the shaped body is freely accessible at least from an entire lower hemisphere for the radiation of the finishing station and the cleaning liquid of the cleaning basin (26) during the cleaning process.

12. The post processing arrangement according to claim 11,
wherein the holder (48) is configured such that a construction platform (6) with one or more shaped bodies (1) adhering thereto can be suspended on the holder or inserted in the holder, wherein the shaped body or the shaped bodies (1) are hanging thereon in a downwardly hanging orientation.

13. The post processing arrangement according to claim 1,
wherein the upper section (40) of the housing in which the finishing station (42) is accommodated, comprises, in an outer wall, a flap (44) which is configured to be opened and which, when opened, allows access to the interior of the finishing station to suspend a shaped body (1) to be post-processed on the holder (48), and to allow for removal of a finished shaped body therefrom.

14. The post processing arrangement according to claim 1,
wherein the upper section (40) and the lower section (20) of the housing are detachably connected to each other.

15. The post processing arrangement according to claim 1,
wherein the upper section (40) has in a bottom wall an opening, and
wherein the lower section (20) has an opening in a top wall which is aligned with the opening of the bottom wall of the upper section,
wherein the openings together form the passage, and
wherein the closure (24) for selectively opening and closing the passage is arranged at the opening in the bottom wall of the upper section (40) or at the opening in the top wall of the lower section (20).

16. The post processing arrangement according to claim 14,
wherein the control unit (4) is housed in a detachable third section (60) of the housing,
wherein the lower section (20) and the third section of the housing are designed such that the third section (60) is configured for attachment to the lower section (20) underneath the lower section, and
wherein there is an electrical connection between the control unit (4) in the third section (60) and the lower and upper sections (20, 40).
